(19) United States
(12) Patent Application Publication
(10) Pub. No.: US 2013/0302852 A1
(43) Pub. Date: Nov. 14, 2013

(54) Hematoxylin Staining Method

(71) Applicants: Bryan W. Barnes, Marana, AZ (US); Charles H. Weidner, Tucson, AZ (US)

(72) Inventors: Bryan W. Barnes, Marana, AZ (US); Charles H. Weidner, Tucson, AZ (US)

(73) Assignee: VENTANA MEDICAL SYSTEMS, INC., Tucson, AZ (US)

(21) Appl. No.: 13/977,902

(22) PCT Filed: Jan. 6, 2012
(86) PCT No.: PCT/US2012/020483

§ 371 Date: Jul. 1, 2013

Related U.S. Application Data
(60) Provisional application No. 61/431,111, filed on Jan. 10, 2011.

(51) Int. Cl. G01N 1/30

(52) U.S. Cl. CPC G01N 1/30
USPC 435/40.51; 435/40.5; 435/283.1

(57) ABSTRACT

The present invention relates to processes for staining biological samples, and in particular to automated processes for staining biological sample with hematoxylin stains. In the processes and systems of the invention, separate hematein and mordant solutions are provided which may be premixed prior to application to a biological sample. This method prevents precipitation common in hematein staining solutions and which fouls automated slide/sample processing equipment.

### FIELD OF THE INVENTION

The present invention relates to processes for staining biological samples, and in particular to automated processes for staining biological sample with hematoxylin stains.

### BACKGROUND OF THE INVENTION

Several histochemical staining protocols, including Hematoxylin and Eosin (H&E) staining and Papanicolaou (PAP) staining, rely on the dye hematoxylin to stain cytological and tissue samples. In particular, hematoxylin staining of cell nuclei is used by pathologists to detect the presence of malignant and/or metastatic cells in a tumor biopsy sample.

Hematoxylin is a naturally-occurring compound found in the red heartwood of trees of the genus Hematoxylon. Hematoxylin itself is colorless in aqueous solution and is not the active ingredient that stains tissue components. Rather, an oxidation product of hematoxylin, hematein, becomes the active staining component of a hematoxylin dye solution, particularly upon complexation with a mordant. Hematein is produced naturally through exposure to air and sunlight. The natural process is termed “ripening,” and can take 3 or more months to provide a solution suitable for staining cells.

Automated staining procedures and systems use mechanical systems to deliver staining solutions to a biological sample. Standard hematein staining procedures utilized a premixed stock containing both the hematoxylin/hematein and a mordant. Precipitates form in these premixed stocks. This is not generally a problem for manual staining procedures, where slides are treated with the hematoxylin staining solution in a container, such as a glass container. However, precipitates are a problem for automated staining systems where the precipitate can foul or clog delivery lines and make cleaning or purging of the delivery lines difficult. These changes to hematoxylin staining solutions can result in staining inconsistencies. For example, hematoxylin stain stocks containing mordant are often allowed to ripen for an extended period of time, allowing developing of hematein-mordant complexes. While this process may allow for good staining results, it also results in formation of the undesirable precipitate. Precipitation is exacerbated by contact with metal. This is especially problematic for automated systems which contain metal parts such as nozzles and sprayheads with very small diameter openings which can be clogged by precipitates.

Therefore, a need exists for development of a hematoxylin staining procedures that are compatible with automated sample processing.

### SUMMARY OF THE INVENTION

The present invention relates to processes for staining biological samples, and in particular to automated processes for staining biological sample with hematoxylin stains.

In some embodiments, the present invention provides processes for staining a biological sample comprising cells, comprising: providing separate hematein and mordant solutions; preparing a fresh hematein-mordant solution by mixing the separate hematein and mordant solutions; and contacting the biological sample with the fresh hematein-mordant solution under conditions such that structures in the cells of the biological sample are stained. In some embodiments, the hematein and mordant solutions are mixed for a time period selected from the group consisting of less than about 4 hours, 3 hours, 2 hours, 1 hour, 45 minutes, 30 minutes, 10 minutes, 5 minutes, 1 minute, 30 seconds and 20 seconds prior to application to the biological sample. In some embodiments, the hematein and mordant solutions are applied to the sample as separate solutions and mixed on the sample to provide a fresh hematein-mordant solution. In some embodiments, the ratio of the separate hematein and mordant solutions is varied to adjust at least one property of the hematein-mordant solution. In some embodiments, the at least one property is stain intensity. In some embodiments, hematein solution is a half-oxidized hematoxylin solution. In some embodiments, the half-oxidized hematoxylin solution comprises an oxidizing agent in an amount sufficient to oxidize about 50 percent of the hematein in the hematein solution. In some embodiments, the mordant solution comprises aluminum sulfate. In some embodiments, the sample is mounted on a slide. In some embodiments, the hematein and mordant solutions comprise a low volatility solvent. In some embodiments, the low volatility solvent is selected from the group consisting of glycerol, polyethylene glycol and propylene glycol.

In some embodiments, the present invention provides processes for staining a biological sample comprising cells, comprising: providing separate hematein and mordant solutions; mixing the separate hematein and mordant solutions immediately before application to the biological sample to provide a hematein -mordant solution; and applying the hematein mordant solution to the biological sample under conditions such that structures in the cells of the biological sample are stained.

In some embodiments, the present invention provides processes for staining a biological sample comprising cells, comprising: providing separate hematein and mordant solutions; mixing the separate hematein and mordant solutions for a time period of less than about 30 minutes prior to application to the biological sample to provide a hematein-mordant solution; and applying the hematein mordant solution to the biological sample under conditions such that structures in the cells of the biological sample are stained. In some embodiments, the hematein solution is a half-oxidized hematein solution. In some embodiments, the mordant solution comprises aluminum sulfate. In some embodiments, the tissue is mounted on a slide. In some embodiments, the hematein and mordant solutions comprise a low volatility solvent. In some embodiments, the low volatility solvent is selected from the group consisting of glycerol, polyethylene glycol and propylene glycol.

In some embodiments, the present invention provides systems for staining a biological sample mounted on a substrate comprising: a first container containing a hematein solution and a second container containing a mordant solution, the first and second containers fluidically connected to a mixing receptacle so that the hematein solution and the mordant solution can be combined to provide a hematein-mordant solution; a substrate holder in fluid communication with the mixing receptacle, so that the hematein-mordant solution can be applied to the biological sample mounted on a substrate when the substrate occupies the substrate holder. In some embodiments, the mixing receptacle is a tube that is fluidically connected to the first and second containers. In some embodiments, the system is automated. In some embodiments, the systems further comprise additional containers containing one or more tissue staining or labeling agents.

In some embodiments, the present invention provides systems for staining a biological sample mounted on a substrate comprising: a first container containing a hematein solution and a second container containing a mordant solution, the first and second containers fluidically connected to dispensers so that the hematein solution and the mordant solution can be applied to the sample mounted on the substrate; a substrate holder in fluid communication with the dispenser, so that the solutions can be applied to the biological sample mounted on a substrate when the substrate occupies the substrate holder.

### Definitions

The singular forms “a,” “an,” and “the” include plural referents unless the context clearly indicates otherwise. Thus, for example, reference to “a host compound” refers to one or more host compounds, such as 2 or more host compounds, 3 or more host compounds, or even 4 or more host compounds.

The term “biological sample” refers to any sample that is obtained from or otherwise derived from a biological entity such as an animal, for example, a sample obtained from a human or a veterinary animal such as a dog, cat, horse or cow. Examples of biological samples include cytology samples, tissue samples and biological fluids. Non-limiting particular examples of biological samples include blood, urine, pre-ejaculate, nipple aspirates, semen, milk, sputum, mucus, pleural fluid, pelvic fluid, sinovial fluid, ascites fluid, body cavity washes, eye brushings, skin scrapings, a buccal swab, a vaginal swab, a pap smear, a rectal swab, an aspirate, a needle biopsy, a section of tissue obtained for example by surgery or autopsy, plasma, serum, spinal fluid, lymph fluid, sweat, tears, saliva, tumors, organs and samples obtained from in vitro cell or tissue cultures. Typically, the sample will be a biopsy sample that has been fixed, processed to remove water and embedded in paraffin or another suitable waxy substance for cutting into tissue sections. Biological samples can be mounted on substrates such as microscope slides for treatment and/or examination.

The term “hematein solution”, as used herein, generically refers both to compositions formed by dissolving hematein (the oxidation product of hematoxylin) directly into a solvent and to compositions formed by dissolving hematoxylin in a solvent and allowing or promoting oxidation of the hematoxylin to hematein.

The term “fresh hematein-mordant solution” as used herein refers to a solution prepared by mixing a hematein solution and a mordant solution either immediately prior to application to a biological sample, for example, by mixing for a time period selected from the group consisting of less than about 4 hours, 3 hours, 2 hours, 1 hour, 45 minutes, 30 minutes, 10 minutes, 5 minutes, 1 minute, 30 seconds and 20 seconds prior to application to the biological sample, or where the hematein and mordant solutions are applied separately to the biological sample and mixed on the sample, for example, by agitation with jets of gas or air.

The term “oxidant” refers to an atom or molecule having a greater reduction potential than a second molecule, for example, a greater reduction potential than hematoxylin such that it will react with and oxidize hematoxylin to hematein. Oxidants include naturally occurring molecular oxygen in the atmosphere that diffuses to and oxidizes hematoxylin and a “chemical oxidant” that is actively combined with hematoxylin (typically in solution) to convert at least a portion of the hematoxylin to hematein Half-oxidized hematoxylin solutions are solutions in which the oxidant is included in an amount which oxidizes approximately one half of the available hematoxylin, as described by Gill, Acta Cytologica, 18(4):300-11 (1974), incorporated herein by reference in its entirety. Examples of useful chemical oxidants include one or more of an iodate salt (such as sodium iodate and potassium iodate), mercuric oxide, a permanganate salt (such as potassium permanganate), a periodate salt (such as sodium periodate and potassium periodate), and a peroxide (such as hydrogen peroxide). In particular embodiments, the chemical oxidant comprises sodium iodate.

The term “mordant” refers to an ionic metal species with which a dye (such as hematein) can form a complex (such as a cationic complex) that serves to bind the dye (such as hematein) to particular cellular components such as nuclear DNA, myelin, elastic and collagen fibers, muscle striations and mitochondria. Examples of mordants include aluminum (for example, in the form of an alum such as aluminum sulfate, aluminum potassium sulfate or aluminum ammonium sulfate), iron, tungsten, zirconium, bismuth, molybdenum (phosphomolybdic acid or molybdic acid), vanadium (vanadate).

### DETAILED DESCRIPTION OF THE INVENTION

The present invention relates to processes for staining biological samples, and in particular to automated processes for staining biological sample with hematoxylin stains. In some embodiments, the present invention provides processes for staining a biological sample where separate hematein and mordant solutions are mixed immediately before application to the biological sample. Surprisingly, it has been found that consistent staining results can be obtained when the hematein and mordant solutions are combined immediately before application as opposed to the use of solutions where the hematein and mordant have been present in the staining solution for an extended period of time. In some embodiments, the hematein and mordant solutions are mixed for a period of time from about less than 4 hours, 3 hours, 2 hours, 1 hour, 45 minutes, 30 minutes, 10 minutes, 5 minutes, 1 minute, 30 seconds or 20 seconds prior to application to the biological sample. In some preferred embodiments, the hematein and mordant solutions are mixed for less than about 1 minute, 30 seconds or 20 seconds prior to application to the biological sample.

The processes of the present invention are compatible with automated processing systems. In some embodiments, the system comprises a separate reservoirs or containers containing separate hematein and mordant solutions. In some embodiments, the systems further comprise a dispensing system that delivers the solutions to the biological sample, preferably a biological sample mounted on a slide. In some embodiments, the hematein and mordant solutions are combined prior to application to the biological sample. In some embodiments, the container or mordant solution and container of hematein solution are pressurized and fluidically connected to a mixing receptacle. The mixing receptacle can be any container capable of holding or transporting the mixed solution such as a rigid or flexible tube. In some embodiments, the mixing receptacle is a tube that is fluidically connected to the dispenser. In some embodiments, the hematein and mordant solutions are fluidically connected to a T-fitting via tubing. The output from the T fitting is in turn fluidically connected to the dispenser. In these embodiments, the mordant and hematein solutions are fed into the T fitting and mixing of the solutions occurs in the tube leading out of the T fitting. In some embodiments, the separate hematein and mordant solution are separately dispensed onto the biologically sample. In these embodiments, the solutions can be allowed to mix by diffusion on the sample or mechanically mixed, for example, by agitation with a pipette.

The amount of chemical oxidant utilized in some embodiments of the composition can be sufficient to completely (such as substantially quantitatively) oxidize the hematoxylin to hematein, or sufficient only to partially oxidize the hematoxylin to hematein. In particular embodiments, more than half of the hematoxylin is oxidized to hematein by the chemical oxidant, and in others, less than half of the hematoxylin is oxidized to hematein by the chemical oxidant. For example, between 1% and 50% of the hematoxylin can be oxidized to hematein by the chemical oxidant, but more typically, between about 10% and about 50% of the hematoxylin is oxidized to hematein by the chemical oxidant. In particular examples, the molar ratio of hematoxylin to oxidant used in the composition is between 6:1 and 1:1. It should be understood that although the chemical oxidant is considered part of the composition, it is converted to its reduction products upon reaction with the hematoxylin, which reduction products will remain in the composition.

The mordant of the composition can be any mordant such as one or more of an aluminum mordant, an iron mordant, a bismuth mordant, a copper mordant, a molybdenum mordant, a vanadium mordant, and a zirconium mordant. In some embodiments, the mordant comprises an alum, and in more particular embodiments, the mordant comprises aluminum sulfate. The mordant can be present in the composition at a concentration greater than the concentration of the hematein in the composition (determinable by refractometry, thin-layer chromatography or spectroscopy), or it can be present in the composition at a concentration less than the concentration of the hematein in the composition. Alternatively, in some embodiments, the molar ratio of hematoxylin to mordant in the composition is between 2:1 and 1:100, and in particular embodiments, the molar ratio of hematoxylin to mordant in the composition is between 1:5 and 1:20.

Accordingly, in some embodiments, the hematein solutions of the present invention comprise hematoxylin (which is oxidized to hematein), a buffer system, an aqueous solvent, and a chemical oxidant. In some embodiments, the buffer is used in a concentration sufficient to control the pH near a pH between 1 and 4, such as a pH near 2.4-2.8. In some embodiments, the buffer system comprises phthalic acid and potassium hydrogen phthalate. In some embodiments, the solvent used to dissolve the hematoxylin comprises an aqueous composition such as composition including water and a low volatility solvent such a polyol. Useful polyols include glycerol, ethylene glycol and propylene glycol. In some embodiments, the mordant solutions of the present invention comprise a mordant, a buffer system, and an aqueous solvent. In some embodiments, the buffer is used in a concentration sufficient to control the pH near a pH between 1 and 4, such as a pH near 2.4-2.8. In some embodiments, the buffer system comprises phthalic acid and potassium hydrogen phthalate. In some embodiments, the solvent used to dissolve the mordant comprises an aqueous composition such as composition including water and a low volatility solvent such a polyol. Useful polyols include glycerol, ethylene glycol and propylene glycol.

The method and systems disclosed herein may be adapted for use with existing automated processing systems. For example, Ventana Medical Systems, Inc. is the assignee of a number of United States patents disclosing systems and methods for performing automated analyses, including U.S. Pat. Nos. 5,650,327, 5,654,200, 6,296,809, 6,352,861, 6,827,901 and 6,943,029, and U.S. published application Nos. 20030211630 and 20040052685, each of which is incorporated herein by reference. These systems may be adapted to be compatible with the present invention. Briefly, the automated slide processing system that is described in the aforementioned applications is a high-volume slide processing system that shuttles trays holding a plurality of slides in substantially horizontal positions (to minimize cross-contamination) between workstations that perform various slide processing operations on the slides. Fresh reagents can be applied to each slide during processing, and cross-contamination of slides with reagents can be substantially eliminated because the slides are treated separately in spaced-apart fashion in the tray. In one configuration, the system includes a radiant heater, a combined de-paraffinizer/stainer/solvent exchanger workstation, a convection oven and a coverslipper. A tray of slides bearing paraffin-embedded tissue samples can be heated under the radiant heater of the system to spread the paraffin in the samples for easier removal and also to adhere the samples to the slides. The tray can then be transported to the multifunctional de-paraffinizer/stainer/solvent exchanger workstation, where slides can be de-paraffinized, stained, and solvent exchanged. A tray of stained slides that is ready for coverslipping can then be shuttled to the coverslipper of the system where coverslips are added to the slides. Once the slides are coverslipped, the tray can then be transported to the convection oven to cure the coverslips on the stained slides. The high volume stainer just described is commercially available from Ventana Medical Systems, Inc, Tucson, Ariz. While the staining system just described can be configured to perform any histological staining process, an exemplary H & E protocol is: a baking step to adhere the samples to the slides, a de-paraffinization step to remove paraffin from paraffin-embedded samples, a hematoxylin staining step (that can utilize the disclosed hematoxylin compositions), a bluing step that raises the pH and turns the hematoxylin blue to provide better contrast with the eosin added downstream, an eosin staining step, a differentiation step that is used to remove excess eosin and turn the eosin various shades of red to pink, a dehydration step to remove water from the sample using 100% ethanol, a step in which the slides are exposed to an elevated temperature and air flow to remove the ethanol, a coverslipping step in which limonene is dispensed to the sample, and a curing step.

While the principles outlined in this disclosure for the use of separate hematein and mordant solutions are applied to variants of aluminum sulfate mordanted stains, it should be understood that they can be applied to other hematoxylin-mordant systems used for histochemical staining of biological samples. Particular examples of alum mordanted hematoxylin histological stains to which a host compound and/or an antioxidant can be added to improve stability include Anderson's, Apathy's, Baker's Bennett's, Bohmer's, Bosma's, Bullard's, Carazzi's, Cole's, Debiden's, de Groot's, Delafield's, Duval's, Ehrlich's, Friedlander's, Gadsdon's, Gage's, Galigher's, Garvey's, Gill's, Graham's, Hamilton's, Harris', Harris & Power's, Haug's, Homeyold's, Kleinenberg's, Krutsay's, Langeron's, Launoy's, Lee's, Lillie's, Lugol's, McLachlan's, Mallory's, Mann's, Martinotti's, Masson's, Mayer's, Mitchell's, Molnar's, Papamiltiades', Pusey's, Rawitz', Reddy's, Sass', Schmorl's, Slidders', Unna's, Watson's, and Weigert & Wright's. Particular examples of iron-mordanted hematoxylin stains include Anderson's, Cretin's, Faure's, Goldman's, Hansen's, Heidenhain's, Janssen's, Kefalas', Krajian's, Krutsay's, La Manna's, Lillie's, Lillie & Earle's, Masson's, More & Bassal's, Murray's, Paquin & Goddard's, Regaud's, Rozas', Seidelin's, Thomas', Weigert's, and Yasvoyn's. A bismuth-mordanted hematoxylin is Roach & Smith's. Copper-mordanted hematoxylins include Bensley's, Cook's and Faure's. A molybdenum-mordanted hematoxylin is Held's. Vanadium-mordanted hematoxylins include Hedenhain's, and Smith's. A zirconium-mordanted hematoxylin is McNulty & Smith's. Formulas and methods of making and using such mordanted hematoxylin solutions can be found, for example, in the StainsFile (an internet resource for histotechnologists maintained by Bryan Llewellyn); Kiernan, “Histological and Histochemical methods: Theory and Practice,” 3rd Ed. Butterworth Heinemann, Oxford, UK; and in Horobin and Kiernan, “Conn's biological stains: a handbook of dyes, stains and fluorochromes for us in biology and medicine,” 10th ed., Oxford: BIOS, ISBN 1859960995, 2002.

In some embodiments, the systems and methods further comprise staining of biological samples with additional stains, such as counterstains. In some embodiments, contacting the sample with a counterstain comprises contacting the sample with one or more of eosin Y, orange G, light green SF yellowish, Bismark Brown, fast green FCF, OA-6, EA25, EA36, EA50 and EA65. The formulas and methods of making such counterstains can be found, for example, in the StainsFile (an internet resource for histotechnologists maintained by Bryan Llewellyn); Kiernan, “Histological and Histochemical methods: Theory and Practice,” 3rd Ed. Butterworth Heinemann, Oxford, UK; and in Horobin and Kiernan, “Conn's biological stains: a handbook of dyes, stains and fluorochromes for us in biology and medicine,” 10th ed., Oxford: BIOS, ISBN 1859960995, 2002. In other embodiments, contacting the sample with the hematoxylin composition comprises a progressive hematoxylin staining protocol. In other embodiments, contacting the sample with the hematoxylin composition comprises a regressive hematoxylin staining protocol. The method can be automated, and can be performed on a biological sample that is supported on a substrate such as a microscope slide. In particular embodiments, the method is used to stain a tissue section or a cytology sample mounted on a microscope slide. In particular embodiments further including a counterstaining step, the method can be an H&E staining method or a PAP staining method, and more particularly an automated H&E or PAP staining method.

Other histological stains useful in conjunction with the staining procedures of the present invention include dyes such as acridine dyes, anthraquinone dyes, arylmethane dyes, azo dyes, diazonium dyes, nitro dyes, phthalocyanine dyes, quinine imine dyes, tetrazolium dyes, thiazole dyes and xanthene dyes. Examples of dyes useful for histological staining include acetyl yellow, acid black 1, acid blue 22, acid blue 93, acid fuchsin, acid green, acid green 1, acid green 5, acid magenta, acid orange 10, acid red 4, acid red 26, acid red 29, acid red 44, acid red 51, acid red 66, acid red 73, acid red 87, acid red 91, acid red 92, acid red 94, acid red 101, acid red 103, acid roseine, acid rubin, acid violet 19, acid yellow 1, acid yellow 9, acid yellow 23, acid yellow 24, acid yellow 36, acid yellow 73, acid yellow S, acid yellow T, acridine orange, acriflavine, alcian blue, alcian yellow, alcohol soluble eosin, alizarin, alizarin blue, alizarin blue 2RC, alizarin carmine, alizarin cyanin BBS, alizarol cyanin R, alizarin red S, alizarin purpurin, aluminon, amido black 10B, amidonaphthol red, amidoschwarz, aniline blue WS, aniline purple, anthracene blue SWR, anthracene blue SWX, auramine 0, azo-eosin, azocarmine B, azocarmine G, azoeosin G, azoic diazo 5, azoic diazo 48, azophloxine, azovan blue, azure A, azure B, azure C, basic blue 8, basic blue 9, basic blue 12, basic blue 15, basic blue 17, basic blue 20, basic blue 26, basic brown 1, basic fuschsin, basic green 4, basic green 5, basic orange 14, basic red 2, basic red 5, basic red 9, basic violet 2, basic violet 4, basic violet 10, basic violet 14, basic yellow 1, basic yellow 2, Biebrich scarlet, Biebrich scarlet R, Bismarck brown Y, brazilein, brazilin, brilliant crocein, brilliant crystal scarlet 6R, calcium red, carmine, carminic acid carmoisine 6R, Celestine blue B, china blue, chlorantine fast red 5B, cochineal, coelestine blue, Chicago blue 4B, chrome violet CG, chromotrope 2R, chromoxane cyanin R, congo Corinth, Congo red, cotton blue cotton red, croceine scarlet crocein scarlet 3B, crocein scarlet MOO, crocin, crystal ponceau 6R, crystal scarlet, crystal violet, dahlia, diamond green B, direct blue 14, direct blue 58, direct red, direct red 10, direct red 28, direct red 80, direct red 81, direct yellow 7, durazol blue 4R, durazol blue 8G, eosin B, eosin bluish, eosin, eosin Y, eosin yellowish, eosinol, Erie garnet B, eriochrome cyanin R, erythrosine B ethyl eosin, ethyl green, ethyl violet, Evan's blue, fast blue B, fast green FCF, fast red B, fast yellow, fast yellow extra, fast yellow G, fat black HB, fluorescein, food green 3, galleon, gallamine blue gallocyanin, gentian violet, helio fast rubin BBL, helvetia blue, Hoffman's violet, hydrazine yellow, imperial red, ingrain blue 1, ingrain yellow 1, INT, Kermes, kermesic acid, kemechtrot, Lac, laccaic acid, Lauth's violet, light green, lissamine fast yellow, lissamine green SF, Luxol fast blue, magenta 0, magenta I, magenta II, magenta III, malachite green, Manchester brown, Martius yellow, mauve, mauveine, merbromin, mercurochrome, metanil yellow, methylene azure A, methylene azure B, methylene azure C, methylene blue, methylene green, methyl blue, methyl green, methyl violet, methyl biolet 2B, methyl violet 10B, milling yellow 3G, mordant blue 3, mordant blue 10, mordant blue 14, mordant blue 23, mordant blue 32, mordant blue 45, mordant red 3, mordant red 11, mordant violet 25, mordant violet 39, naphthalene blue black, naphthol blue black, naphthol green B, naphthol yellow S, natural black 1, natural red, natural red 3, natural red 4, natural red 8, natural red 16, natural red 24, natural red 25, natural red 28, natural yellow 6, NBT, neutral red, new fuchsin, Niagara blue 3B, night blue, Nile blue, Nile blue A, Nile blue sulfate, Nile red, nitro BT, nitro blue tetrazolium, nuclear fast red, oil red 0, orange G, orcein, pararosanilin, Perkin's violet, phloxine B, picric acid, Ponceau 2R, Ponceau 6R, Ponceau B, Ponceau de Xylidine, Ponceau S, pontamine sky blue 5B, primula, primuline, purpurin, pyronin B, pyronin G, pyronin Y, rhodamine B, rosanilin, rose Bengal, saffron, safranin 0, scarlet R scarlet red, Scharlach R, shellac, sirius red F3B, sirius red 4B, sirius supra blue F3R, solochrome cyanin R, soluble blue, solvent black 3, solvent blue 38, solvent red 23, solvent red 24, solvent red 27, solvent red 45, solvent yellow 94, spirit soluble eosin, Sudan III, Sudan IV, Sudan black B, Sudan red BK, sulfur yellow S, Swiss blue, tartrazine, thioflavine S, thioflavine T, thionin, toluidine blue, toluoyline red, tropaeolin G, trypaflavine, trypan blue, uranin, Vicoria blue 4R, Victoria blue B, Victoria blue R, Victoria green B, water blue I, water soluble eosin, woodstain scarlet, Xylidine ponceau, and yellowish eosin, and combinations thereof. Formulas and methods of making and using histochemical dye solutions discussed in this paragraph (such as in “special stain” procedures in particular histological contexts, or as counterstains) can be found, for example, in the StainsFile (an internet resource for histotechnologists maintained by Bryan Llewellyn); Kiernan, “Histological and Histochemical methods: Theory and Practice,” 3rd Ed. Butterworth Heinemann, Oxford, UK; and in Horobin and Kiernan, “Conn's biological stains: a handbook of dyes, stains and fluorochromes for us in biology and medicine,” 10th ed., Oxford: BIOS, ISBN 1859960995, 2002. The contents of the two bound references cited immediately above are incorporated by reference herein.

### Experimental

### Example 1

### Preparation of Solutions

The following solutions were prepared: Solution A:

| Buffered KAl(SO₄)₂ solution | pH = 2.59 | |
|---|---|---|
| Propylene glycol | 25 | mL |
| DI H₂O | 75 | mL |
| Phthalic acid | 0.90 | g |
| Potassium hydrogen phthalate | 0.43 | g |
| KAl(SO₄)₂•12H₂O | 1.2 | g |

Solution B

| Buffered hematein solution | pH = 2.71 | |
|---|---|---|
| Propylene glycol | 25 | mL |
| DI H₂O | 75 | mL |
| Phthalic acid | 0.90 | g |
| Potassium hydrogen phthalate | 0.43 | g |
| Hematoxylin | 1.2 | g |
| Sodium iodate | 0.12 | g |

For solutions A and B, propylene glycol is heated on a hotplate at 60° C. The phthalic acid is added and the composition is heated until the solid is dissolved. The heat is turned off and a solution of the potassium hydrogen phthalate in the DI H₂O is added to the propylene glycol solution while stirring. The potassium aluminum sulfate is added to solution A as a solid. Solution A is then stirred overnight and then filtered using 25 micron fluted filter paper. The hematoxylin is added to solution B and the composition is stirred for approximately 15 minutes. The solid sodium iodate is then added and the solution is stirred overnight and then filtered using 25 micron fluted filter paper.

### Example 2

### Staining of Biological Samples

Materials: KA1(SO₄)₂ buffered solution (double strength; 2× Solution A); Hematein buffered solution (double strength; 2× Solution B), 50/50 propylene glycol/H₂O) with 1% Merpol wash; 50/50 0.1 Tris bluing; 95% propylene glycol; Transfer fluid; 3×3 MTB slides.

The following protocol was used on a thick film (open) box. The slides are manually deparaffinized, lightly blotted and placed in the box. 400 μL of 2× Solution A is dispensed onto the tissue, followed immediately by 400 μL, of 2× Solution B. The slide is then incubated for 3 minutes. The slides are then rinsed two times for 10 seconds with 800 μL 1% aqueous Merpol. The slides are then treated with 800 μL 95% propylene glycol for 10 seconds. The slides are next rinsed three times with 800 μL transfer fluid for 10 seconds each. A Coverslip is then applied on a Sakkura TissueTek instrument.

This protocol was used on a duplicate slide, as well as slides with the following modifications. Two slides were incubated with the separate Solutions A and B for 6 minutes with no mixing and two slides were incubated for 8 minutes with Solutions A and B which were manually mixed after addition of Solution B with a pipettor.

### Example 3

### Preparation of Two Part Staining Solutions

Solution A: 0.75 M phthalate buffered KA1(SO₄)₂ To 250 ml of propylene glycol 8.97 g phthalic acid is added and the mixture stirred at 60° C. until the solid dissolves. Potassium hydrogen phthalate solution (4.3 g in 750 mL DI H₂O) is added with stirring and the solution is removed from the heat. 12.0 g KA1(SO₄)₂.12H₂O is then added and the mixture stirred until it is homogenous. The solution is then filtered. The pH is 2.59.

Solution B: 0.75 M phthalate buffered hematein. To 250 mL propylene glycol 8.97 g phthalic acid is added and the mixture stirred at 60° C. until the solid dissolves. Potassium hydrogen phthalate solution (4.3 g in 750 mL DI H₂O) is added with stirring and the solution is removed from the heat. 12.0 g Hematoxylin is added with stirring. After 15-20 minutes, 1.2 g sodium iodate is added and the mixture stirred overnight. The solution is then filtered. The pH is 2.71.

These solutions were used for the experiments described below.

### Example 4

### Automated Mixing of Staining Solutions

Separate A and B solutions were put into bottles on a breadboard and the outputs from the bottles were connected by a T fitting to allow premixing of the two separate solutions. A slide (3×3 manually deparaffinized) was placed in an open thin film staining box and the tissue covered with 800 μL of 50/50 propylene glycol/H2O mixture to prevent drying of the tissue. The premix apparatus described above was pressurized and 2-3 mL of the solutions were dispensed into a tube and transferred to the open thin film box. The 50/50 solution was air-knived from the tissue sample and 800 μL of the premixed Solution A and B was dispensed on top of the slide. The slide was incubated for three minutes and then the remaining steps from the protocol in Example 2 were carried out. This procedure was repeated on additional slides with a 3 minute repeat treatment with the stain mix (i.e., two 3 minute incubations) with a six minute incubation. The remaining steps from the protocol in Example 2 were then carried out.

### Example 5

### Staining of Biological Samples

The fresh solutions described above were used to stain slides for demonstrations of two-part hematoxylin staining. All slides were stained with a mix made using the pressurized breadboard apparatus as described in Example 4. Four slides were stained for 3 or 6 minute incubation times, in duplicate. Following application of the stain, the slides were processed as described in Example 2. The slides were evaluated by a pathologist for nuclear stain intensity. The slides were compared to slides stained with a traditional hematein solution (denoted as NGH III) in which the hematoxylin and mordant had been mixed for an extended period of time prior to the experiment.

The following treatments were tested.

### Treatment

NGH III—3 min
NGH III—3 min
NGH III—6 min.
NGH III—6 min.
Premix A and B—3 min.
Premix A and B—3 min
Premix A and B—3 min
Premix A and B—6 min.
Premix A and B—6 min.
No premix A and B—3 min.
No premix A and B—3 min.
No premix A and B—6 min
No premix A and B—6 min.
Manual mix A and B—3 min
Manual mix A and B—3 min
Manual mix A and B—6 min.
Manual mix A and B—6 min.
   It was found that using fresh hematein-mordant solutions produced satisfactory staining results.

### Example 6

### Staining of Biological Samples

The two part staining solutions can be used by mixing different volumes of each part, provided the stoichiometry of the component chemicals (aluminum salt/hematein) are maintained via adjustment of the appropriate solution concentrations.Further illustration of the invention is exemplified by this alternative formulation for Solution B from Example 3: Hematoxylin (2.4 g) is added with stirring to 50 mL of propylene glycol, followed by 150 mL of DI H₂O. Once all of the solid is dissolved, sodium iodate (0.24 g) is added and the mixture is stirred overnight, filtered and is then ready for staining experiments. (Solution B1). Another embodiment of the hematein-containing solution in which the concentration of the hematein is reduced, but the buffer system is maintained at 0.075 M, is exemplified by the following: Propylene glycol (31.25 mL) was heated to 60° C., and phthalic acid (1.12 g) was added with stirring until dissolved. Remove the mixture from the heat, and add a solution of potassium hydrogen phthalate (0.54 g) in 93.75 mL DI H₂O to it. Hematoxylin (1.0 g) was then added with stirring, and after dissolution, sodium iodate (0.1 g) was added and the mixture stirred overnight. After filtration, the mixture was ready for use. (Solution B2).

Yet another embodiment in which both the hematein concentration and the concentration of the buffer system are reduced is illustrated by the following: Propylene glycol (31.25 mL) was heated to 60° C., and phthalic acid (0.56 g) was added with stirring until dissolved. Remove the mixture from the heat, and add a solution of potassium hydrogen phthalate (0.27 g) in 93.75 mL DI H₂O to it. Hematoxylin (1.0 g) was then added with stirring, and after dissolution, sodium iodate (0.1 g) was added and the mixture stirred overnight. After filtration, the mixture was ready for use. (Solution B3).

These examples were all tested for stability at elevated temperature in contact with a variety of metals to assess their relative propensity toward forming precipitate: For this testing, 25 mL aliquots of each formulation of the hematin solutions described above were dispensed into borosilicate glass jars with Teflon-sealed lids, and then placed in a 45° C. oven. Each week, over the course of 33.5 days [which is approximately equivalent to twelve (12) months exposure at room temperature (RT)], the solutions were inspected and any change was noted. For each fluid, controls were set aside at 45° C. and at RT. The standard formulations for the Symphony N2+ Hematoxylin solution were also tested for reference. The Symphony N2+ Hematoxylin solution is described in formulation 2 in FIG. 2 of U.S. Pat. Publ. 2008/0227143, the entire contents of which are incorporated herein by reference.

| | Week 1 | Week 4 | Week 1 | Week 4 |
|---|---|---|---|---|
| Solution | (RT) | (RT) | (45° C.) | (45° C.) |
| Symphony N2+ | No | Light | Moderate | Heavy |
| Hematoxylin | precipitate | precipitate | precipitate | precipitate |
| Solution | | | | |
| Hematein B1 | No | No | No | No |
| | precipitate | precipitate | precipitate | precipitate |
| Hematein B2 | No | No | No | No |
| | precipitate | precipitate | precipitate | precipitate |
| Hematein B3 | No | No | No | No |
| | precipitate | precipitate | precipitate | precipitate |

All publications and patents mentioned in the above specification are herein incorporated by reference. Various modifications and variations of the described method and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are obvious to those skilled in the field of this invention are intended to be within the scope of the following claims.

1. An automated process for staining a biological sample comprising cells, comprising:
providing separate hematein and mordant solutions;
preparing a fresh hematein-mordant solution by mixing the separate hematein and mordant solutions; and
contacting said biological sample with said fresh hematein-mordant solution under conditions such that structures in the cells of said biological sample are stained.

2. The process of claim 1, wherein said hematein and mordant solutions are mixed for a time period selected from the group consisting of less than about 4 hours, 3 hours, 2 hours, 1 hour, 45 minutes, 30 minutes, 10 minutes, 5 minutes, 1 minute, 30 seconds and 20 seconds prior to contacting biological sample.

3. The process of claim 1, wherein said hematein and mordant solutions are applied to the biological sample as separate solutions and mixed on the biological sample to provide a fresh hematein-mordant solution.

4. The process of claim 1, wherein the ratio of the separate hematein and mordant solutions is varied to adjust at least one property of the hematein-mordant solution.

5. The process of claim 4, wherein said at least one property is stain intensity.

6. The process of claim 1, wherein said hematein solution is a half-oxidized hematoxylin solution.

7. The process of claim 6, wherein said half-oxidized hematein solution comprises an oxidizing agent in an amount sufficient to oxidize about 50 percent of the hematoxylin in said hematein solution.

8. The process of claim 1, wherein said mordant solution comprises aluminum sulfate.

9. The process of claim 1, wherein said biological sample is mounted on a slide.

10. The process of claim 1, wherein said hematein and mordant solutions comprise a low volatility solvent.

11. The process of claim 10, wherein said low volatility solvent is selected from the group consisting of glycerol, polyethylene glycol and propylene glycol.

12. A system for staining a biological sample mounted on a substrate comprising:
a first container containing a hematein solution and a second container containing a mordant solution, said first and second containers fluidically connected to a mixing receptacle so that said hematein solution and said mordant solution can be combined to provide a hematein-mordant solution;
a substrate holder in fluid communication with said mixing receptacle, so that said hematein-mordant solution can be applied to said biological sample mounted on a substrate when said substrate occupies said substrate holder.

13. The system of claim 12, wherein said mixing receptacle is a tube that is fluidically connected to said first and second containers.

14. The system of claim 12, wherein said system is automated.

15. The system of claim 12, further comprising additional containers containing one or more tissue staining or labeling agents.
